(19) United States
(12) Patent Application Publication
(10) Pub. No.: US 2012/0197846 A1
(43) Pub. Date: Aug. 2, 2012

(54) DYNAMIC RECOVERY OF SERVER APPLICATIONS

(75) Inventors: Peter Peng, Beijing (CN); Victor Liu, Beijing (CN); Zhenghua Xu, Beijing (CN)

(73) Assignee: Computer Associates Think, Inc., Islandia, NY (US)

(21) Appl. No.: 13/018,746

(22) Filed: Feb. 1, 2011

(51) Int. Cl. G06F 17/30

(52) U.S. Cl. 707/679; 707/E17.007

(57) ABSTRACT

A continuously running application may be dynamically recovered. A database replica server may be directed to temporarily spool data changes in a database master server that stores application data associated with an application running on a web front-end master server. A specified rewind point may be obtained from among a plurality of existing rewind points of the application data stored in the database replica server. The database replica server may be directed to rewind the application data to a specified rewind point. An indication of data to be recovered in the rewound application data may be obtained. The web front-end master server may be directed to restore the data corresponding to the indication. The database replica server may be directed to resume replication of data changes in the database master server.

### FIELD OF THE DISCLOSURE

This disclosure relates to dynamically recovering applications, such as server applications in an enterprise environment.

### BACKGROUND

Many server applications are widely deployed—sometimes world-wide—and are considered mission-critical in enterprise environments. One example of such an application is Microsoft SharePoint Server™ (“SharePoint”), which is a server application for an enterprise that facilitates collaboration, provides full content management features, carries out business processes, and provides access to information essential to organizational goals and processes. Server applications can be very complicated and include several components including multiple servers and software modules. The components can be installed and configured as stand-alone or server-farm implementations. Usually for a medium or large server farm, there can be hundreds of gigabytes (GB) of data. Furthermore, daily data change may often be at a gigabyte level.

Mission-critical and widely-deployed server applications introduce significant requirements for availability and disaster recovery solutions. There are existing technologies for addressing such requirements. However, conventional technologies do not provide dynamic, or on-the-fly, recovery capabilities. Some conventional technologies only support farm-level recovery, which means that an entire server farm must be restored to a previous point of time even if only a small portion of data (e.g., a single document or website) needs to be recovered. Typically, server-application data is stored in a database. Conventional database recover procedures may include (1) rewinding the database to a previous point in time earlier than the point of the data to be restored and (2) rewinding and recovering the application servers one by one. Such recovery procedures consume an excessive amount of time because, for example, unnecessary data is inevitably recovered in addition to the desired portion of data.

During the recovery period, all functionalities of a server application will be offline and unavailable. After recovery is complete, restarting recovery protection on a server farm generally requires resynchronization of the entire server farm. Owing to the mission-critical nature of many server applications, users cannot afford downtime of the entire server application just to recover a small portion of data.

### SUMMARY

One or more implementations of the present technology provide dynamic, or on-the-fly, recovery capabilities for server applications and/or other protected applications. These capabilities allow application data to be recovered without interrupting application continuity, thus avoiding application downtime. The dynamic recovery can include recovery of an application site, a content database, a single document, a specific version of a document, and/or other data associated with protected applications. Dynamic recovery of only desired data can be faster than recovering an entire server farm. In accordance with some implementations, resynchronization may be unnecessary since protection and/or replication on one or more servers may continue to run during recovery. One aspect of this disclosure relates to a system configured for dynamic recovery of a server application. The system may include a web front-end master server, a web front-end replica server, a database master server, a database replica server, a protection manager server, and/or other components, which may be communicatively coupled via a network. The network may include the Internet and/or other networks.

The web front-end master server may be configured to provide one or more applications to end-users via the network. Such applications may include server applications and/or other protected applications. As mentioned above, one example of such an application is Microsoft SharePoint Server™ (“SharePoint”), which is a server application for an enterprise that facilitates collaboration, provides full content management features, carries out business processes, and provides access to information essential to organizational goals and processes. The web front-end master server may include electronic storage, one or more processors, and/or other components. The processor(s) of the web front-end master server may be configured to execute one or more computer program modules, which may include a data recovering module.

The web front-end replica server may be configured to replicate the web front-end master server. This may add a level of protection to applications provided by the web front-end master server. The web front-end replica server may include electronic storage, one or more processors, and/or other components.

The database master server may be configured to store application data and provide application data to other components of the system. Application data may be received from the web front-end master server and/or the web front-end replica server. The database master server may include electronic storage, one or more processors, and/or other components.

The database replica server may be configured to replicate the database master server. This may add a level of protection to application data stored by the database master server. The database replica server may include electronic storage, one or more processors, and/or other components. The processor(s) of the database replica server may be configured to execute one or more computer program modules, which may include a data processing module.

The protection manager server may be configured to manage protection and recovery procedures on the web front-end master server, the web front-end replica server, the database master server, the database replica server, and/or other components of the system. The protection manager server may include electronic storage, one or more processors, and/or other components. The processor(s) of the protection manager server may be configured to execute one or more computer program modules, which may include a recovery coordinating module.

The recovery coordinating module may be configured to manage protection and recovery procedures within the system. The recovery coordinating module may be in communication with the data processing module, the data recovering module, and/or other components of the system. The recovery coordinating module may be configured to direct the data processing module, the data recovering module, and/or other components of the system to perform operations of a recovery process in sequence or in parallel.

The recovery coordinating module may be configured to facilitate various user interactions with the system. One or more user interfaces may provide an interface between the system and one or more users. In some implementations, the recovery coordinating module may be configured to provide to a user, for presentation and/or selection, existing rewind points of application data, metadata associated with application data, sources and/or destinations of data to be recovered, and/or other information associated with a recovery process.

The data processing module may be configured to rewind application data stored by the electronic storage data processing module of the database replica server to a specified point of time or rewind point. Such a point in time or rewind point may include target data to be restored. The data processing module may be configured to start application services and/or application database after rewinding application data. The data processing module may be configured to discover application data and/or provide the discovered application data to the recovery coordinating module. The discovered application data may be presented to a user in a logical view, a raw data view, and/or other view. The data processing module may be configured to send data to be recovered to the data recovering module.

The data recovering module may be configured to receive application data to be restored from the data processing module. The data processing module may be configured to restore the received data within the web front-end master server. Such data may be restored via one or more application recovery interfaces.

Another aspect of this disclosure relates to a method for dynamically recovering a continuously running application. The method may include directing a database replica server to temporarily spool data changes in a database master server that stores application data associated with an application running on a web front-end master server. The method may include obtaining a specified rewind point from among a plurality of existing rewind points of the application data stored in the database replica server. The method may include directing the database replica server to rewind the application data to a specified rewind point. The method may include obtaining an indication of data to be recovered in the rewound application data. The method may include directing the web front-end master server to restore the data corresponding to the indication. The method may include directing the database replica server to resume replication of data changes in the database master server.

The recovery coordinating module may be configured to manage protection and recovery procedures within the system. The recovery coordinating module may be in communication with the data processing module, the data recovering module, and/or other components of the system. The recovery coordinating module may be configured to direct the data processing module, the data recovering module, and/or other components of the system to perform operations of a recovery process in sequence or in parallel. The recovery coordinating module may be configured to facilitate various user interactions with the system. One or more user interfaces may provide an interface between the system and one or more users. In some implementations, the recovery coordinating module may be configured to provide to a user, for presentation and/or selection, existing rewind points of application data, metadata associated with application data, sources and/or destinations of data to be recovered, and/or other information associated with a recovery process.

These and other features and advantages of the present technology will be apparent through the detailed description and the drawings attached hereto. It is also to be understood that both the foregoing general description and the following detailed description are exemplary and not restrictive of the scope of the technology.

### BRIEF DESCRIPTION OF THE DRAWINGS

FIG. 1 illustrates a system configured for dynamic recovery of a server application, in accordance with one or more implementations.

FIG. 2 is a process sequence chart illustrating a process for dynamic recovery of a server application, in accordance with one or more implementations.

### DETAILED DESCRIPTION

One or more implementations of the present technology provide dynamic, or on-the-fly, recovery capabilities for server applications and/or other protected applications. These capabilities allow application data to be recovered without interrupting application continuity, thus avoiding application downtime. The dynamic recovery can include recovery of an application site, a content database, a single document, a specific version of a document, and/or other data associated with protected applications. Dynamic recovery of only desired data can be faster than recovering an entire server farm. In accordance with some implementations, resynchronization may be unnecessary since protection and/or replication on one or more servers may continue to run during recovery.

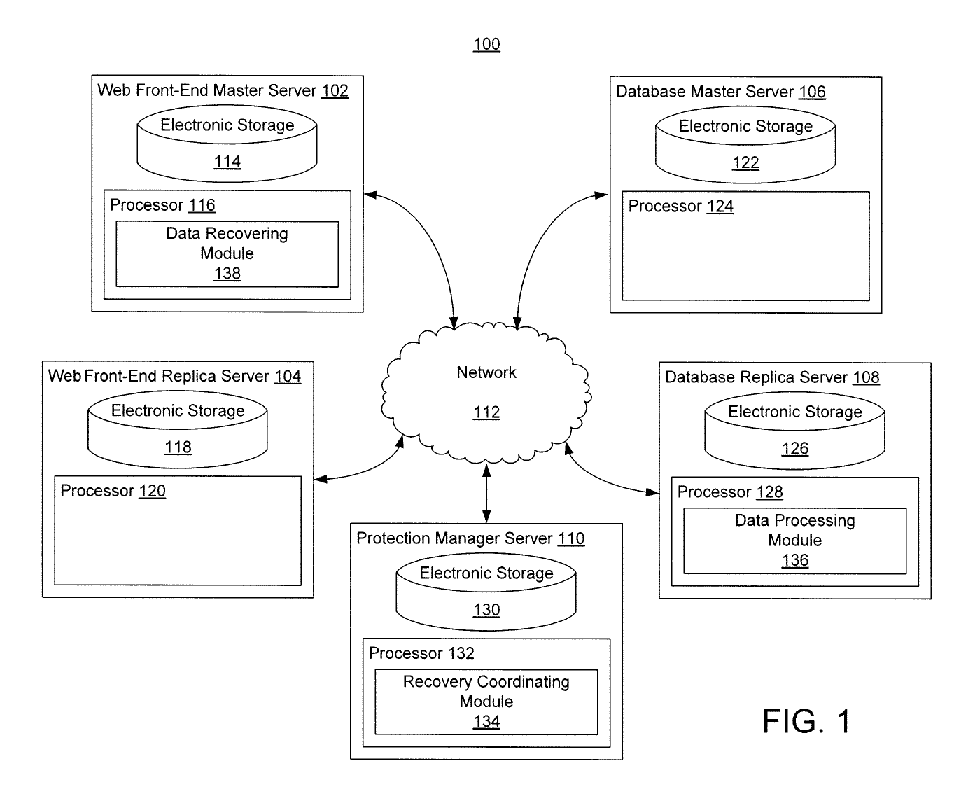

Referring now to the figures, FIG. 1 illustrates a system 100 configured for dynamic recovery of a server application, in accordance with one or more implementations. As depicted in FIG. 1, the system 100 may include a web front-end master server 102, a web front-end replica server 104, a database master server 106, a database replica server 108, a protection manager server 110, and/or other components, which may be communicatively coupled via a network 112. The network 112 may include the Internet and/or other networks. It is appreciated that this is not intended to be limiting, and that the scope of this disclosure includes implementations in which the web front-end master server 102, the web front-end replica server 104, the database master server 106, the database replica server 108, the protection manager server 110, and/or other components are operatively linked via some other communication media. It is further appreciated that the system 100 may include any number of other servers and/or clients in communication with the components of the system 100 depicted in FIG. 1, in accordance with various implementations.

The web front-end master server 102 may be configured to provide one or more applications to end-users via the network 112. Such applications may include server applications and/or other protected applications. As mentioned above, one example of such an application is Microsoft SharePoint Server™ (“SharePoint”), which is a server application for an enterprise that facilitates collaboration, provides full content management features, carries out business processes, and provides access to information essential to organizational goals and processes. The web front-end master server 102 may include electronic storage 114, one or more processors 116, and/or other components. The electronic storage 114 and the processor(s) 116 are described in further detail below.

The web front-end replica server 104 may be configured to replicate the web front-end master server 102. This may add a level of protection to applications provided by the web front-end master server 102. The web front-end replica server 104 may include electronic storage 118, one or more processors 120, and/or other components. The electronic storage 118 and the processor(s) 120 are described in further detail below.

The database master server 106 may be configured to store application data and provide application data to other components of the system 100. Examples of application data may include configurations, settings, a list or other indication of servers included in a server farm, indications of roles associated with individual servers, security information and settings, information related to customized resources, and/or other data associated with an application and/or server(s). Application data may be received from the web front-end master server 102 and/or the web front-end replica server 104. The database master server 106 may include electronic storage 122, one or more processors 124, and/or other components. The electronic storage 122 and the processor(s) 124 are described in further detail below.

The database replica server 108 may be configured to replicate the database master server 106. This may add a level of protection to application data stored by the database master server 106. The database replica server 108 may include electronic storage 126, one or more processors 128, and/or other components. The electronic storage 126 and the processor(s) 128 are described in further detail below.

The protection manager server 110 may be configured to manage protection and recovery procedures on the web front-end master server 102, the web front-end replica server 104, the database master server 106, the database replica server 108, and/or other components of the system 100. The protection manager server 110 may include electronic storage 130, one or more processors 132, and/or other components. The electronic storage 130 and the processor(s) 132 are described in further detail below.

Generally speaking, electronic storage such as the electronic storage 114 of the web front-end master server 102, the electronic storage 118 of the web front-end replica server 104, the electronic storage 122 of the database master server 106, the electronic storage 126 of the database replica server 108, and/or the electronic storage 130 of the protection manager server 110 may comprise electronic storage media that electronically stores information. The electronic storage media of such electronic storage may include system storage that is provided integrally (i.e., substantially non-removable) with individual ones of the servers 102, 104, 106, 108, and/or 110. The electronic storage media of such electronic storage may include removable storage that is removably connectable to individual ones of the servers 102, 104, 106, 108, and/or 110 via, for example, a port (e.g., a USB port, a firewire port, etc.) or a drive (e.g., a disk drive, etc.). Electronic storages within the system 100 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storages within the system 100 may store software algorithms, information determined by one or more processors (e.g., the processor 116, the processor 120, the processor 124, the processor 126, and/or the processor 130) and/or other information that enables the system 100 to function as described herein. Each individual one of electronic storages 114, 118, 122, 126, and/or 130 may be a separate component within the system 100, or individual ones of the electronic storages 114, 118, 122, 126, and/or 130 may be provided integrally with one or more other components of the system 100.

Individual ones of the processors 116, 120, 124, 128, and/or 132 may be configured to provide processing capabilities in the system 100. As such, individual ones of the processors 116, 120, 124, 128, and/or 132 may include one or more of a digital processor, an analog processor, a digital circuit designed to process information, an analog circuit designed to process information, a state machine, and/or other mechanisms for electronically processing information. Although the processors 116, 120, 124, 128, and/or 132 are shown in FIG. 1 as a single entities, this is for illustrative purposes only. In some implementations, individual ones of the processors 116, 120, 124, 128, and/or 132 may each include a plurality of processing units. These processing units may be physically located within the same device or computing platform, or individual ones of the processors 116, 120, 124, 128, and/or 132 may represent processing functionality of a plurality of devices operating in coordination.

As is shown in FIG. 1, individual ones of the processors 116, 120, 124, 128, and/or 132 may be configured to execute one or more computer program modules, in accordance with one or more implementations. The one or more computer program modules may include one or more of a recovery coordinating module 134, a data processing module 136, a data recovering module 138, and/or other modules. Individual ones of the processors 116, 120, 124, 128, and/or 132 may be configured to execute the modules 134, 136, and/or 138 by software; hardware; firmware; some combination of software, hardware, and/or firmware; and/or other mechanisms for configuring processing capabilities on individual ones of the processors 116, 120, 124, 128, and/or 132.

It should be appreciated that although the modules 134, 136, and 138 are illustrated in FIG. 1 as being respectively located within single processing units, in implementations in which individual ones of the processors 116, 120, 124, 128, and/or 132 include multiple processing units, one or more of the modules 134, 136, and/or 138 may be wholly or partially duplicated in other ones of the multiple processing units. The description of the functionality provided by the different modules 134, 136, and/or 138 described below is for illustrative purposes, and is not intended to be limiting, as any of the modules 134, 136, and/or 138 may provide more or less functionality than is described. For example, one or more of the modules 134, 136, and/or 138 may be eliminated, and some or all of its functionality may be provided by other ones of the modules 134, 136, and/or 138. As another example, individual ones of the processors 116, 120, 124, 128, and/or 132 may be configured to execute one or more additional modules that may perform some or all of the functionality attributed below to one of the modules 134, 136, and/or 138.

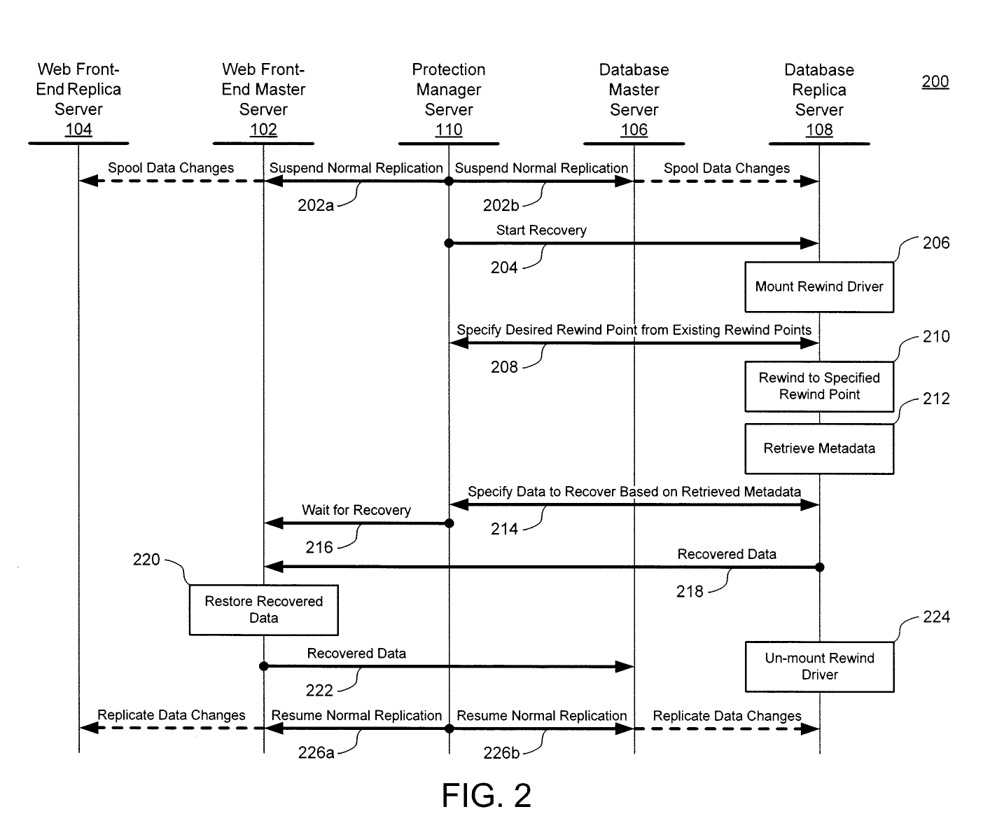

The recovery coordinating module 134 may reside within the protection manager server 110 and may be executed by the processor(s) 132, according to some implementations. The recovery coordinating module 134 may be configured to manage protection and recovery procedures within the system 100. The recovery coordinating module 134 may be in communication with the data processing module 136, the data recovering module 138, and/or other components of the system 100. The recovery coordinating module 134 may be configured to direct the data processing module 136, the data recovering module 138, and/or other components of the system 100 to perform operations of a recovery process in sequence or in parallel. Exemplary operations are described in connection with FIG. 2.

The recovery coordinating module 134 may be configured to facilitate various user interactions with the system 100. One or more user interfaces (not depicted in FIG. 1) may provide an interface between the system 100 and one or more users. Such user interface(s) enable data, results, and/or instructions and any other communicable items, collectively referred to as “information,” to be communicated between the user and the system 100. Examples of interface devices suitable for inclusion as a user interface include a keypad, buttons, switches, a keyboard, knobs, levers, a display screen, a touch screen, speakers, a microphone, an indicator light, an audible alarm, and a printer. In some implementations, the recovery coordinating module 134 may be configured to provide to a user, for presentation and/or selection, existing rewind points of application data, metadata associated with application data, sources and/or destinations of data to be recovered, and/or other information associated with a recovery process.

The data processing module 136 may reside within the database replica server 108 and may be executed by the processor(s) 128, according to some implementations. The data processing module 136 may be configured to rewind application data stored by the electronic storage data processing module 126 of the database replica server 108 to a specified point of time or rewind point. Such a point in time or rewind point may include target data to be restored. The data processing module 136 may be configured to start application services and/or application database after rewinding application data. The data processing module 136 may be configured to discover application data and/or provide the discovered application data to the recovery coordinating module 134. The discovered application data may be presented to a user in a logical view, a raw data view, and/or other view. The data processing module 136 may be configured to send data to be recovered to the data recovering module 138.

The data recovering module 138 may reside within the web front-end master server 102 and may be executed by the processor(s) 116, according to some implementations. The data recovering module 138 may be configured to receive application data to be restored from the data processing module 136. The data processing module 136 may be configured to restore the received data within the web front-end master server 102. Such data may be restored via one or more application recovery interfaces (e.g., API or command line).

FIG. 2 is a process sequence chart illustrating a process 200 for dynamic recovery of a server application, in accordance with one or more implementations. As depicted in FIG. 2, the process 200 may include operations associated with the web front-end master server 102, the web front-end replica server 104, the database master server 106, the database replica server 108, and/or the protection manager server 110. However, these operations are intended to be illustrative. In some implementations, the process 200 may be accomplished with one or more additional operations and/or interaction not described, and/or without one or more of the operations discussed. Additionally, the order in which the operations of the process 200 are illustrated in FIG. 2 and described below is not intended to be limiting. Furthermore, the operations of the process 200 may be performed by and among one or more servers in addition to those depicted in FIG. 2.

In some implementations, the process 200 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of the method 200 in response to instructions stored electronically on one or more electronic storage media. The one or more processing devices may include one or more devices configured through hardware, firmware, and/or software to be specifically designed for execution of one or more of the operations of the process 200.

At operation 202a, the protection manager server 110 directs the web front-end master server 102 such that normal replication of a server application should cease. Resultantly, data changes in the web front-end master server 102 may be temporarily spooled on the web front-end replica server 104. At operation 202b, the protection manager server 110 directs the database master server 106 such that normal replication of application data should cease. Resultantly, data changes in the database master server 106 may be temporarily spooled on the database replica server 108. According to some implementations, spooling data changes may include storing the data changes in a spool directory. The data changes stored in the spool directory may later be recalled to update the corresponding application data directory. Operations 202a and 202b may be performed contemporaneously or in sequence, according to various implementations. The recovery coordinating module 134 may perform operations 202a and 202b, in some implementations.

At operation 204, the protection manager server 110 directs the database replica server 108 to commence data recovery. In implementations where a plurality of database replica servers are included in the system 100, operation 204 may include locating a particular database replica server that is protecting the database master server 106. According to some implementations, operation 204 may be performed by the recovery coordinating module 134.

At operation 206, the database replica server 108 may mount a rewind driver. In some implementations, the rewind driver may be mounted to all replicated data directories. This may ensure that the replicated data directories will not be modified during rewind and/or recovery. This may guarantee that normal replication of data changes in the database master server 106 can continue after the process 200 is completed. The data processing module 136 may perform operation 206, in accordance with some implementations.

At operation 208, existing rewind points are presented to a user such that a desired rewind point can be specified. In some implementations, the existing rewind points for data changes of the database replica server 108 are collected by the data processing module 136. The recovery coordinating module 134 may present the existing rewind points to the user and allow the user to specify the desired rewind point. In some implementations, specification of the desired rewind point may be performed automatically by the recovery coordinating module 134. In order to restore some specific data, the database replica server 108 may be rewound to a rewind point that corresponds to a point in time prior to the point in time when the specific data is operated.

At operation 210, the database replica server 108 is rewound to the specified rewind point. In accordance with some implementations, the data processing module 136 may perform operation 210.

At operation 212, the database replica server 108 retrieves metadata associated with application data stored therein. According to some implementations, such metadata may include logical information of user data, information related to websites associated with a server application, information related to documents included in websites associated with the server application, information related to versions of such documents, and/or other metadata associated with stored application data. The data processing module 136 may perform operation 212, in some implementations.

At operation 214, the retrieved metadata is presented to a user such that corresponding data to be restored can be specified. In some implementations, such presentation may be performed by the recovery coordinating module 134. The metadata may be logically located in multi-layer requiring the user to expand the data to view associated sub-data. According to some implementations, for example, a user may select an application website node. By expanding the website node, the user may view a list of documents stored in this website. By expanding a document node associated with a given document, the user may view a list of versions of that document. In accordance with some implementations, specification of the data to be restored may be performed automatically by the recovery coordinating module 134.

At operation 216, the protection manager server 110 directs the web front-end master server 102 to wait for recovery. Operation 216 may involve communication between the recovery coordinating module 134 and the data recovering module 138.

At operation 218, recovered data is sent from the database replica server 108 to the web front-end master server 102. Operation 218 may involve communication between the data processing module 136 and the data recovering module 138. Operation 218 may be performed responsive to the protection manager server 110 notifying the database replica server 108 to retrieve the data specified in operation 214.

At operation 220, the recovered data is restored in the web front-end master server 102. The data recovering module 138 may perform operation 220, according to some implementations.

At operation 222, the database master server 106 is updated with the recovered data.

At operation 224, the database replica server 108 may un-mount the rewind driver. In some implementations the data processing module 136 may perform operation 224. Operation 224 may be performed responsive to notification from the recovery coordinating module 134 and/or the data recovering module 138 to un-mount the rewind driver.

At operation 226a, the protection manager server 110 directs the web front-end master server 102 such that normal replication of a server application should resume. Resultantly, replication of data changes in the web front-end master server 102 are resumed in the web front-end replica server 104. At operation 226b, the protection manager server 110 directs the database master server 106 such that normal replication of application data should resume. Resultantly, replication of data changes in the database master server 106 are resumed in the database replica server 108. According to some implementations, the data changes temporarily stored in the spool directory may be recalled to update the corresponding application data directory. Operations 202a and 202b may be performed contemporaneously or in sequence, according to various implementations. The recovery coordinating module 134 may perform operations 202a and 202b, in some implementations.

Although the present technology has been described in detail for the purpose of illustration based on what is currently considered to be the most practical and preferred implementations, it is to be understood that such detail is solely for that purpose and that the present technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

What is claimed is:

1. A method for dynamically recovering a continuously running application, the method comprising:
directing a database replica server to temporarily spool data changes in a database master server that stores application data associated with an application running on a web front-end master server;
obtaining a specified rewind point from among a plurality of existing rewind points of the application data stored in the database replica server;
directing the database replica server to rewind the application data to a specified rewind point;
obtaining an indication of data to be recovered in the rewound application data;
directing the web front-end master server to restore the data corresponding to the indication; and
directing the database replica server to resume replication of data changes in the database master server.

2. The method of claim 1, wherein the application runs uninterruptedly while the web front-end master server restores the data.

3. The method of claim 1, further comprising directing a web front-end replica server to temporarily spool data changes in a web front-end master server.

4. The method of claim 3, further comprising directing the web front-end replica server to resume replication of data changes in the web front-end master server.

5. The method of claim 1, further comprising directing the database replica server to mount a rewind driver.

6. The method of claim 5, wherein the rewind driver is mounted to all replicated data directories within the database replica server.

7. The method of claim 6, wherein mounting the rewind driver to all of the replicated data directories ensures that the replicated data directories will be unmodified during a rewind of the database replica server or during recovery of data to be restored.

8. The method of claim 1, wherein obtaining the specified rewind point includes presenting the plurality of existing rewind points to a user.

9. The method of claim 1, further comprising obtaining metadata associated with application data stored by the database replica server.

10. The method of claim 9, wherein obtaining the indication of the data to be recovered includes presenting the metadata to a user.

11. A system configured to dynamically recover a continuously running application, the system comprising:
one or more processors configured to execute computer program modules, the computer program modules comprising:
a recovery coordinating module configured to:
direct a database replica server to temporarily spool data changes in a database master server that stores application data associated with an application running on a web front-end master server;
obtain a specified rewind point from among a plurality of existing rewind points of the application data stored in the database replica server;
direct the database replica server to rewind the application data to a specified rewind point;
obtain an indication of data to be recovered in the rewound application data;
direct the web front-end master server to restore the data corresponding to the indication; and
direct the database replica server to resume replication of data changes in the database master server.

12. The system of claim 11, wherein the application runs uninterruptedly while the web front-end master server restores the data.

13. The system of claim 11, wherein the protection manager server is further configured to direct a web front-end replica server to temporarily spool data changes in a web front-end master server.

14. The system of claim 13, wherein the protection manager server is further configured to direct the web front-end replica server to resume replication of data changes in the web front-end master server.

15. The system of claim 11, wherein the protection manager server is further configured to direct the database replica server to mount a rewind driver.

16. The system of claim 15, wherein the rewind driver is mounted to all replicated data directories within the database replica server.

17. The system of claim 16, wherein mounting the rewind driver to all of the replicated data directories ensures that the replicated data directories will be unmodified during a rewind of the database replica server or during recovery of data to be restored.

18. The system of claim 11, wherein the protection manager server is further configured to obtain the specified rewind point by presenting the plurality of existing rewind points to a user to make the specification.

19. The system of claim 11, wherein the protection manager server is further configured to obtain metadata associated with application data stored by the database replica server.

20. The system of claim 19, wherein the protection manager server is further configured to obtain the indication of the data to be recovered by presenting the metadata to a user to make the indication.
